(19) United States
(12) Patent Application Publication
(10) Pub. No.: US 2005/0276042 A1
(43) Pub. Date: Dec. 15, 2005

(54) Lighting device

(76) Inventor: Ko-Liang Ho, Taipei (TW)

Correspondence Address: KO-LIANG HO, P.O. BOX 26-757, TAIPEI, 106, TW

(21) Appl. No.: 10/867,554

(22) Filed: Jun. 10, 2004

(51) Int. Cl. F21L 4/00

(52) U.S. Cl. 362/205

(57) ABSTRACT

A lighting device has an elongated housing, a lighting module assembled in the elongated housing, a reflection mask connecting the elongated housing to sandwich the lighting module therebetween, and an exterior casing enclosing the elongated housing, the lighting module and the reflection mask. The elongated housing has two buckling members upwardly extending from two lateral sides thereof to engage with a control module, and the elongated housing has two slots formed in the lateral sides thereof to engage with two lateral sidewalls of a reverse U-shaped press disposed therein. The exterior casing includes a keystroke cover corresponding to the keystroke set and having two clamping portions extending downwardly at two opposite ends thereof so as to penetrate the keystroke set and the reverse U-shaped press sequentially to the reverse U-shaped press, whereby the keystroke cover can force the exterior casing and the keystroke set onto the reverse U-shaped press.

### BACKGROUND OF THE INVENTION

1. Field of the Invention

The present invention relates to a lighting device. The invention relates also to a flashlight that provides simple assembly and easy manipulation with convenience.

2. Background of the Invention

A conventional flashlight 1a, illustrated in FIG. 1, includes an exterior casing 11a, a base (not shown) disposed in the exterior casing 11a, and a battery pack (not shown) arranged in the exterior casing 11a for power. The base further includes a printed circuit board, a switch set, and a switch 12a assembled on the exterior casing 11a. The switch 12a relates to the switch set disposed on the base. The conventional flashlight 1a further includes a bulb arranged on a front head thereof. However, elements in the conventional flashlight 1a are assembled together by screws via a screwdriver or welding via a solder gun, resulting in low assembly efficiency and great inconvenience. The bulb of the conventional flashlight 1a is a kind of incandescent bulb that consists of finely coiled wire filaments in a glass bulb filled with an inert gas. The wire's resistance to the flow of electricity causes it to become hot enough to glow and to give off light. The resistance causes the bulb to get hot. About 90 percent of the energy used by an incandescent bulb becomes heat and 10 percent becomes light. Power consumption and costs will not be saved if incandescent bulbs are still provided. Furthermore, the present of the bulb will repeat due to the large power consumption.

Hence, an improvement over the prior art is required to overcome the disadvantages thereof.

### SUMMARY OF INVENTION

The present invention has been accomplished under the circumstances in view. It is therefore the main object of the present invention to provide a lighting device that is simply assembled and easily manipulated with great convenience and efficiency.

It is therefore the secondary object of the present invention to provide a lighting device that maintains high lighting efficiency and conserves power without changing battery cells or lighting devices, so as to provide convenient manipulation.

According to the present invention, a lighting device includes an elongated housing, a lighting module assembled in the elongated housing, a reflection mask connecting to the elongated housing to sandwich the lighting module therebetween, and an exterior casing enclosing the elongated housing, the lighting module and the reflection mask. The elongated housing has two buckling members upwardly extending from two lateral sides thereof to engage with a control module disposed therein; the elongated housing includes two slot formed on the lateral sides thereof to engage with two lateral sidewalls of a reverse U-shaped press disposed therein. The exterior casing includes a keystroke cover corresponding to the keystroke set and having two clamping portions extending downwardly at two opposite ends thereof, so that the keystroke set and the reverse U-shaped press sequentially penetrate the reverse U-shaped press, whereby the keystroke cover can force the exterior casing and the keystroke set onto the reverse U-shaped press.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of a conventional flashlight;

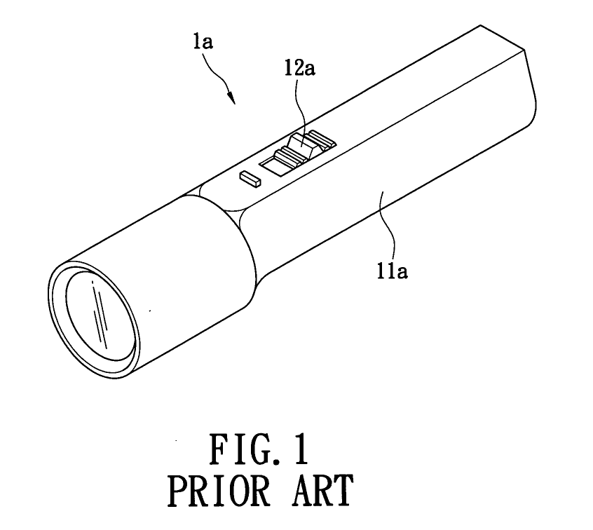

FIG. 2 is an exploded view of a lighting device of a first embodiment according to the present invention;

FIG. 3 is a perspective view of the lighting device of the first embodiment according to the present invention; and

FIG. 4 is an exploded view of a lighting device of a second embodiment according to the present invention.

### DETAILED DESCRIPTION OF THE EMBODIMENTS

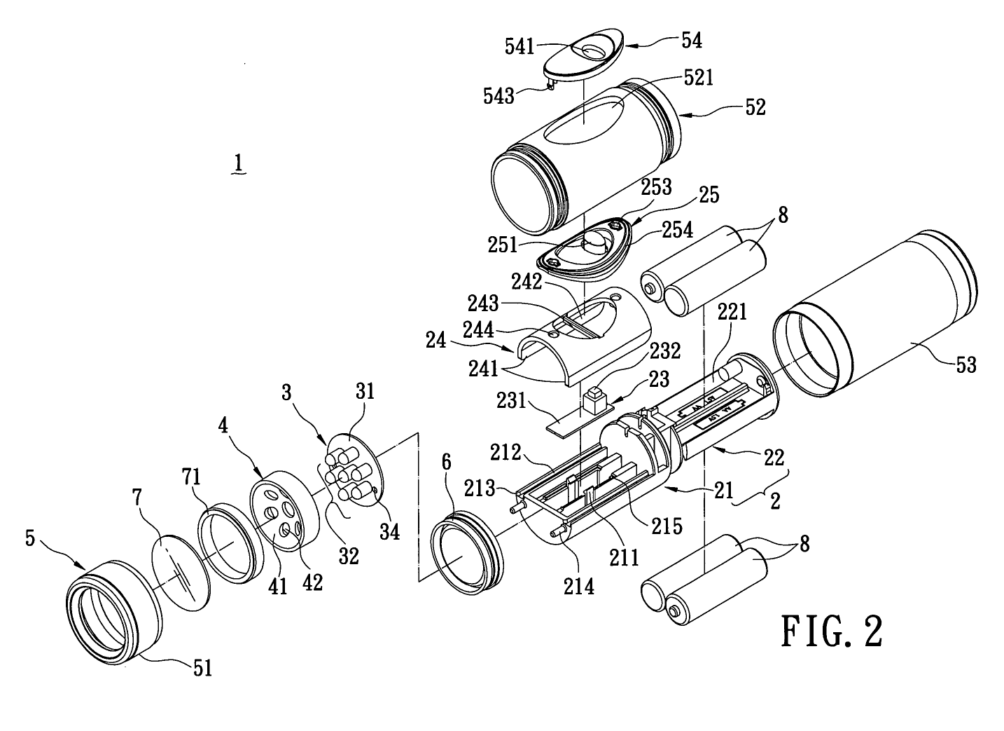

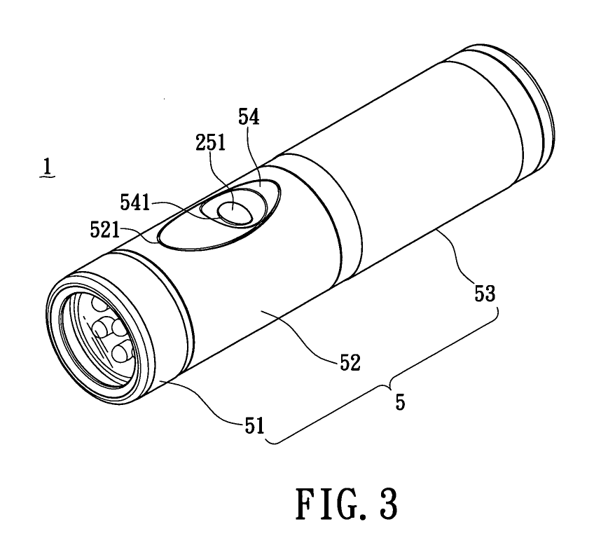

Referring to FIGS. 2 and 3, a first embodiment of a lighting device 1 according to the present invention discloses an elongated housing 2 having a control module 23 and a keystroke set 25, a lighting module 3 assembled in the an elongated housing 2 and electrically connected to the control module 23, a reflection mask 4 connecting to the elongated housing 2 to sandwich the lighting module 3 therebetween, and an exterior casing 5 enclosing the elongated housing 2, the lighting module 3 and the reflection mask 4. The exterior casing 5 has a keystroke cover 54 corresponding to the keystroke set 25. The elongated housing 2 has two buckling members 211 upwardly extending from two lateral sides thereof to engage with the control module 23. The elongated housing 2 includes two slots 212 formed on the two lateral sides thereof to engage with two lateral sidewalls 241 of a reverse U-shaped press 24 disposed therein and abutting against the control module 23. The keystroke cover 54 has two clamping portions 543 extending downwardly at two opposite ends thereof so that the exterior casing 5, the keystroke set 25 and the reverse U-shaped press 24 sequentially penetrate the reverse U-shaped press 24, whereby the keystroke cover 54 can force the exterior casing 5 and the keystroke set 25 onto the reverse U-shaped press 24.

The keystroke set 25 is disposed on the reverse U-shaped press 24. The control module 23 includes a control board 231 and at least one sensor member arranged on the control board 231, and the keystroke set 25 has at least one key corresponding to the sensor member. In this embodiment, the sensor member is a first sensor member 232, and the key is a first key 251. The elongated housing 2 includes a front base 21 and a rear base 22. The control module 23 is disposed in the front base 21, the reverse U-shaped press 24 engages with the front base 21, and the keystroke set 25 is arranged on the reverse U-shaped press 24. The buckling members 211 extends upwardly from two lateral sides of the front base 21 to engage with the control board 231 of the control module 23. The front base 21 has a longitudinal supporting portion 215 arranged to support the control module 23. The slots 212 are formed on the lateral sides of the front base 21; the front base 21 has two guiding faces 213 formed at respective heads of the slots 212 to guide the two lateral sidewalls 241 of the reverse U-shaped press 24. The lighting device 1 further includes at least one battery 8, and the rear base 22 has at least one receiving cavity 221 relating to the battery 8. The battery 8 is disposed in the receiving cavity 221 and electrically connected to the control module 23.

The lighting module 3 is assembled to a head of the front base 21 and electrically connects to the control module 23. The lighting module 3 includes a circuit board 31 and a plurality of lighting members disposed on the circuit board 31. The front base 21 of the elongated housing 2 has an orientation post 214 extending from the head thereof, and the circuit board 31 of the lighting module 3 has an orientation hole 34 accommodating the orientation post 214 of the front base 21. At least one of the lighting members is an LED. The reverse U-shaped press 24 has an opening 242 formed in a top thereof and an immobile beam 243 laterally arranged over the opening 242 and abutting against the control board 231. The first sensor member 232 is exposed by the opening 242 and abuts against the first key 241. The keystroke cover 54 includes a first hole 541 formed on a top thereof and relating to the first key 251, so as to expose the first key 251 for operation. The reverse U-shaped press 24 has two fastening holes 244 formed in two opposite ends of a top thereof, the keystroke set 25 has two through holes 253 formed in two opposing ends thereof and respectively relating to the two fastening holes 244, and the keystroke cover 54 includes two clamping portions 543 extending downwardly at two opposite ends thereof to relate the through holes 253, respectively. The two clamping portions 543 respectively penetrate the through holes 253 of the keystroke set 25 and two fastening holes 244 of the reverse U-shaped press 24 sequentially to engage with the top of the reverse U-shaped press 24.

The reflection mask 4 includes a reflection face 41 having a plurality of holes 42 formed therein. The lighting members are exposed by the reflection mask 4 via the holes 42. The reflection face 41 is made of a reflective material to reflect the light emitted by the lighting members. The reflection face 41 has a gradual curvature from an inside to an outside thereof in order to avoid the light diverging. The exterior casing 5 includes a main lid 52 enclosing the front base 21 of the elongated housing 2, a front lid 51 assembled to a front of the main lid 52, and a rear lid 53 assembled to a rear of the main lid 52. Both the front lid 51a and the rear lid 53 are screwed on. The main lid 52 has male or female screw threads formed thereon, and the front lid 51a and the rear lid 53 have female or male screw threads correspondingly, so that the user can rotate the front lid 51a and the rear lid 53 to screw on or off the main lid 52. The main lid 52 has a cutout 521 formed in a top thereof. The keystroke cover 54, the cutout 521, the keystroke set 25 and the opening 242 of the reverse U-shaped press 24 are ovoid in shape. The keystroke cover 54, the cutout 521 and the opening 242 of the reverse U-shaped press 24 are smaller than the keystroke set 25. The clamping portions 543 of the keystroke cover 54 penetrate the cutout 251, the through holes 253 of the keystroke set 25, and the fastening holes 244 of the reverse U-shaped press 24 to engage with the reverse U-shaped press 24, so that the keystroke cover 54 is capable of forcing the main lid 52 and the keystroke set 25 to the reverse U-shaped press 24. The keystroke set 25 further includes a step portion 254 surrounding a bottom thereof and adjacent to the cutout 521 to abut against the main lid 52. The lighting device 1 further includes a main-lid orientation ring 6 arranged between the lighting module 3 and the head of the front base 21. The main lid 52 connects the front base 21 of the elongated housing 2 via the main-lid orientation ring 6. With respect to FIG. 3, the lighting device 1 further includes a converging lens 7 arranged between the reflection mask 4 and the front lid 51, and a press circle 71 disposed between the reflection mask 4 and the converging lens 7. Light can thus be conversably emitted.

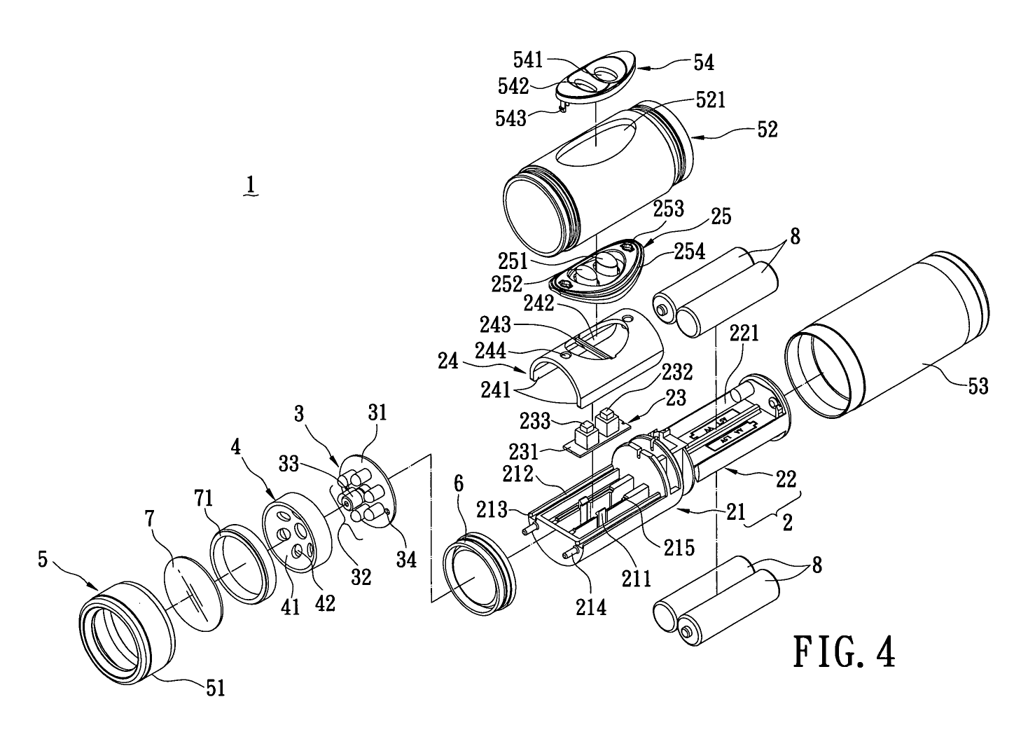

FIG. 4 illustrates a second embodiment according to the present invention, in which at least one of the lighting members is an LD 33, the control module 23 further includes a second sensor member 233 electrically connecting the LD 33, the keystroke set 25 includes a second key 252 relating to the second sensor member 233, and the keystroke cover 54 includes a second hole 542 relating to the second key 252. In this embodiment, the second key 252 is used to control the LD 33 for indications with lasers, and the first key 251 is still used to control the LED 32 for luminance with visible lights. The LED 32 and the LD 33 use the same circuit board and battery pack, so that the power consumption will not increase but rather be reduces due to characteristics of the LED that can provide high luminance, low power consumption, and long service life without changing the battery.

The present invention provides plurality of clamping mechanisms. For example, the buckling members 211 are engaged to abut against control board 231 of the control module 23, while the control module 23 is assembled to the front base 21 of the elongated housing 2. The orientation posts 214 engaged with the orientation holes 34 of the lighting module 3, while the lighting module 3 is assembled to the elongated housing 2. The slots 212 of the front base 21 accommodate the two lateral sidewalls 241 of the reverse U-shaped press 24, while the reverse U-shaped press 24 is assembled to the front base 21, and then the immobile beam 243 of the reverse U-shaped press 24 abuts against the control board 231 of the control module 23. The two clamping portions 543 respectively penetrate the through holes 253 of the keystroke set 25 and two fastening holes 244 of the reverse U-shaped press 24 sequentially to engage with the top of the reverse U-shaped press 24, while the exterior casing 5 is assembled to the elongated housing 2; therefore, the elongated housing 2 can tightly connect to the main lid 52. The elongated housing 2 is then connects the main lid 52, the front lid 51 and the rear lid 53 screws to the main lid 52 for convenient manipulation and disassembly with screws and solder gun, so as to reduce manufacturing steps and increase processing efficiency.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A lighting device, comprising:
an elongated housing including a front base, a rear base, a control module disposed in the front base, a reverse U-shaped press engaging with the front base and abutting against the control module, and a keystroke set arranged on the reverse U-shaped press, wherein the control module includes a control board and a first sensor member arranged on the control board, and the keystroke set has a first key corresponding to the first sensor member;
a lighting module assembled to a head of the front base and electrically connecting to the control module, wherein the lighting module includes a circuit board and a plurality of lighting members disposed on the circuit board;
a reflection mask connecting the head of the front base to sandwich the lighting module therebetween, the lighting members being exposed by the reflection mask; and
an exterior casing enclosing the elongated housing, the lighting module and the reflection mask, the exterior casing having a keystroke cover corresponding to the keystroke set;
wherein the front base has a pair of buckling members extending from two lateral sides thereof to engage with the control board of the control module.

2. The lighting device as claimed in claim 1, wherein the front base includes two slots formed on the lateral sides thereof in order to engage with two lateral sidewalls of the reverse U-shaped press.

3. The lighting device as claimed in claim 1, wherein the front base has a longitudinal supporting portion arranged to support the control module.

4. The lighting device as claimed in claim 1, wherein the front base has an orientation post extending from the head thereof, and the circuit board of the lighting module has an orientation hole accommodating the orientation post of the front base.

5. The lighting device as claimed in claim 1, wherein the reverse U-shaped press has an opening formed in a top thereof, and the first sensor member is exposed via the opening to abut against the first key.

6. The lighting device as claimed in claim 5, wherein the reverse U-shaped press includes an immobile beam laterally arranged over the opening and abutting against the control board.

7. The lighting device as claimed in claim 1, wherein the reverse U-shaped press has two fastening holes formed in two opposite ends of a top thereof, the keystroke set has two through holes formed in two opposing ends thereof and respectively relating to the two fastening holes, and the keystroke cover includes two clamping portions extending downwardly at two opposite ends thereof to relate the through holes respectively, whereby the two clamping portions respectively penetrate the through holes of the keystroke set and two fastening holes of the reverse U-shaped press sequentially to engage with the top of the reverse U-shaped press.

8. The lighting device as claimed in claim 7, wherein the exterior casing includes a main lid enclosing the front base of the elongated housing, a front lid assembled to a front of the main lid, and a rear lid assembled to a rear of the main lid.

9. The lighting device as claimed in claim 8, further includes a converging lens arranged between the reflection mask and the front lid.

10. The lighting device as claimed in claim 8, wherein the main lid has a cutout formed in a top thereof, the clamping portions of the keystroke cover penetrate the cutout, the through holes of the keystroke set, and the fastening holes of the reverse U-shaped press to engage with the reverse U-shaped press, whereby the keystroke cover is capable of forcing the main lid and the keystroke set to the reverse U-shaped press.

11. The lighting device as claimed in claim 1, wherein the keystroke cover includes a first hole formed in a top thereof, relating to the first key and exposing the first key for operation, and at least one of the lighting members is an LED.

12. The lighting device as claimed in claim 1, wherein at least one of the lighting members is an LD, the control module includes a second sensor member electrically connecting the LD, the keystroke set has a second key corresponding to the second sensor member, and the keystroke cover has a second hole relating to the second key.

13. The lighting device as claimed in claim 1, wherein the reflection mask includes a reflection face with gradual curvature from an inside to an outside thereof.

14. A lighting device, comprising:
an elongated housing including a front base, a rear base, a control module disposed in the front base, a reverse U-shaped press engaging with the front base and abutting against the control module, and a keystroke set arranged on the reverse U-shaped press, wherein the control module includes a control board and at least one sensor member arranged on the control board, and the keystroke set has at least one key corresponding to the sensor member;
a lighting module assembled to a head of the front base and electrically connecting to the control module, wherein the lighting module includes a circuit board and a plurality of lighting members disposed on the circuit board;
a reflection mask connecting to the head of the front base to sandwich the lighting module therebetween, wherein the reflection mask includes a reflection face with a plurality of holes formed therein, and the lighting members are exposed by the reflection mask via the holes; and
an exterior casing enclosing the elongated housing, the lighting module and the reflection mask, the exterior casing having a keystroke cover corresponding to the keystroke set;
wherein the elongated housing has a pair of buckling members extending from two lateral sides thereof to engage with the control board of the control module; and
wherein the keystroke cover includes two clamping portions extending downwardly at two opposite ends thereof, whereby the two clamping portions respectively penetrate the keystroke set and two fastening holes of the reverse U-shaped press sequentially to engage with the reverse U-shaped press.

15. The lighting device as claimed in claim 14, wherein the elongated housing includes two slots formed in the lateral sides thereof to engage with two lateral sidewalls of the reverse U-shaped press.

16. The lighting device as claimed in claim 14, wherein the front base has an orientation post extending from the head thereof, and the circuit board of the lighting module has an orientation hole accommodating the orientation post of the front base.

17. The lighting device as claimed in claim 14, wherein at least one of the lighting members is an LED or an LD.

18. The lighting device as claimed in claim 14, wherein the exterior casing includes a main lid enclosing the control module and the keystroke set of the elongated housing, a front lid assembled to a front of the main lid, and a rear lid assembled to a rear of the main lid.

19. The lighting device as claimed in claim 18, wherein the main lid has a cutout formed in a top thereof, the clamping portions of the keystroke cover penetrate the cutout, the through holes of the keystroke set, and the fastening holes of the reverse U-shaped press to engage with the reverse U-shaped press, whereby the keystroke cover is capable of forcing the main lid, the keystroke set to the reverse U-shaped press

20. A lighting device, comprising:
an elongated housing including a control module, a reverse U-shaped press abutting against the control module and a keystroke set;
a lighting module assembled to the elongated housing and electrically connecting the control module;
a reflection mask connecting the elongated housing to sandwich the lighting module therebetween; and
an exterior casing enclosing the elongated housing, the lighting module and the reflection mask, the exterior casing having a keystroke cover corresponding to the keystroke set;
wherein the elongated housing has a pair of buckling members extending from two lateral sides thereof to engage with the control module, and the elongated housing includes two slot formed in the lateral sides thereof in order to engage with two lateral sidewalls of the reverse U-shaped press;
wherein the keystroke cover includes two clamping portions extending downwardly at two opposite ends thereof, whereby the two clamping portions respectively penetrate the keystroke set and two fastening holes of the reverse U-shaped press sequentially to engage with the reverse U-shaped press, and the keystroke cover forces the exterior casing and the keystroke set onto the reverse U-shaped press.
